(19) United States
(12) Patent Application Publication
(10) Pub. No.: US 2026/0211088 A1
(43) Pub. Date: Jul. 23, 2026

(54) SYSTEM FOR THE DETECTION OF A MOTOR VEHICLE, COMPRISING A MODULE FOR EMITTING AND A MODULE FOR RECEIVING A LIGHT BEAM

(71) Applicant: VALEO VISION, Bobigny (FR)

(72) Inventors: Matheo GOURDON, Bobigny (FR); Sidahmed BEDDAR, Bobigny (FR); Geoffrey PIQUARD, Bobigny (FR); Pierre RENAUD, Bobigny (FR); Mickael MIMOUN, Bobigny (FR)

(73) Assignee: VALEO VISION, Bobigny (FR)

(21) Appl. No.: 19/142,495

(22) PCT Filed: Dec. 22, 2023
(86) PCT No.: PCT/EP2023/087517

§ 371 Date: Jun. 23, 2025

(30) Foreign Application Priority Data
Dec. 23, 2022 (FR) FR2214442
Oct. 6, 2023 (FR) FR2310727

(51) Int. Cl. G01S 7/484; G01S 7/4865; G01S 7/487; G01S 17/10; G01S 17/931

(52) U.S. Cl. CPC G01S 7/484; G01S 7/4865; G01S 7/487; G01S 17/10; G01S 17/931

(57) ABSTRACT

The invention relates to a lighting system of a motor vehicle. The lighting system includes an emission module having a lighting module and a modulation unit, a reception module for receiving a light beam. The lighting system also includes a calculation unit for receiving a first instruction for emitting a first photometric function, the calculation unit being arranged to generate a first modulating data sequence having a first duty factor, and in that the calculation unit is able to receive a second instruction for emitting a given second photometric function and is arranged to generate a second modulating data sequence having a second duty factor that differs from the first duty factor.

### TECHNICAL FIELD

The invention relates to the field of automotive lighting and to functions for the detection of an object by an automotive vehicle and estimation of the distance separating this object from the vehicle. More precisely, the invention relates to a luminous system for an automotive vehicle that is capable of performing range-finding functions by means of the light that it emits.

### BACKGROUND OF THE INVENTION

In the automotive field, it is known to use a pulsed light beam emitted by a luminous module of a luminous system for an automotive vehicle to perform a given photometric function.

Conventionally, the light source used to emit this light beam is controlled by a PWM electrical signal (PWM standing for Pulse Width Modulation). The light source is thus periodically activated and deactivated by this PWM signal, and hence the emitted light beam is composed of successive light pulses that follow one after another at a rate that is sufficiently high for the human eye to no longer be able to distinguish between them. The intensity of the emitted light beam depends on the duty cycle of this PWM signal, and hence it is possible to control said intensity by adjusting this duty cycle of the PWM signal, and therefore to perform a photometric function.

Beyond performance of one or more photometric functions, such as a daytime running light or low beam, various functions may be performed by this type of luminous module. For example, the light source of the luminous module may be controlled so that the pulses of the emitted light beam transport a data sequence. The luminous system may thus be equipped with a reception module in order to receive the emitted light beam, after reflection from an object near the vehicle. A computation unit of the automotive vehicle may then, after detection of the data sequence in the received light beam, determine the time of flight of the emitted light beam and therefore evaluate the distance separating the vehicle from the object.

In this way, the light beam may play its original role, namely performance of a photometric function, while allowing the luminous system to perform a range-finding function, which may be particularly advantageous for example in the context of advanced driver-assistance functions or in the context of autonomous or semi-autonomous vehicles.

However, this type of system has a drawback when the luminous module has to perform various photometric functions. Specifically, certain functions may be carried out through the same exit surface of a luminous module, in order to ensure a harmonious illuminated appearance is achieved for these two functions and thus give the automotive vehicle a luminous signature. This is for example the case for the DRL and position-light functions, or even for stop-light and tail-light functions (DRL standing for Daytime Running Light). These photometric functions are defined by regulation and have substantially different luminous intensities. For example, the DRL function has a luminous intensity ten times greater than that of the position-light function. Thus, conventionally, the electrical power supplied to the light source of the luminous module is substantially reduced in order to pass from one of these functions to the other.

However, when the luminous module is in addition performing a range-finding function, this solution is not envisionable. Specifically, reducing electrical power to perform the less powerful luminous function would make the system unsuitable for detection of objects located in a far field.

### SUMMARY OF THE INVENTION

There is thus a need for a luminous system of an automotive vehicle, comprising a luminous module capable of performing, at the same time, two different photometric functions and a range-finding function, the performance of the range-finding function remaining substantially constant whatever the photometric function performed.

The present invention falls within this context, and aims to meet this need.

To these ends, one subject of the invention is a luminous system for an automotive vehicle, comprising:
a. an emission module comprising a luminous module capable of emitting a light beam, the spectrum of which has at least one portion in the visible spectrum, and a modulation unit that is capable of receiving a data sequence, called the modulating data sequence, and that is arranged to modulate said emitted light beam using the received data sequence;
b. a receiving module capable of receiving a light beam, wherein the receiving module comprises an elementary acquisition module comprising a photodetector capable of converting a light signal it receives into an electrical signal.

The system according to the invention is characterized in that it comprises a computation unit capable of receiving a first instruction to emit a given first photometric function and arranged to, on reception of the first instruction, generate a first modulating data sequence having a first duty cycle and to transmit said first modulating data sequence to the modulating unit with a view to emission of a first modulated light beam by the luminous module, in that the computation unit is capable of receiving a second instruction to emit a given second photometric function and in that the computation unit is arranged to, on reception of the second instruction, generate a second modulating data sequence having a second duty cycle different from the first duty cycle and to transmit said second modulating data sequence to the modulating unit with a view to emission of a second modulated light beam by the luminous module.

It will thus be understood that the invention makes provision, when a first photometric function is required, to modulate a light beam emitted by the luminous module with a first data sequence. The first modulated light beam thus performs the first photometric function. The resulting light beam may, for example, be a pulsed beam, each pulse corresponding to one or more consecutive high values of the first modulating sequence and the interval separating two consecutive pulses corresponding to one or more consecutive low values of the first modulating sequence. Each pulse of the modulated light beam is emitted with a peak luminous power, the average luminous power of the emitted first modulated light beam, required to perform the photometric function, thus being defined by the peak luminous power and the duty cycle of the modulating data sequence. Since the modulating sequence is generated cyclically, the emitted first modulated light beam will periodically contain this sequence while continuously performing the photometric function. The computation unit may thus detect, on the basis of the electrical signal converted by the photodetector, the presence of this modulating sequence in a beam received by the reception module and thus detect the presence of an object in the environment of the vehicle and estimate its distance from the vehicle.

The invention further makes provision, when another photometric function is required, to modulate the light beam emitted by the luminous module with another data sequence of different duty cycle. The second modulated light beam thus performs the second photometric function. However, because of the change in duty cycle, the average power of the second modulated beam corresponds to that required to perform this second function, without the peak luminous power having to be modified. Therefore, the range of the range-finding function may remain unchanged, even when the second photometric function requires a lower luminous intensity than the first.

In the present invention, what is meant by duty cycle of a data sequence is the ratio between the number of high values and the total length of the data sequence. In the case where the data sequence is a binary sequence, the duty cycle therefore corresponds to the ratio between the number of bits of value “1” of the binary sequence and the total number of bits of this sequence.

Preferably, the computation unit is arranged to generate said first modulating data sequence and said second modulating data sequence from the same initial pseudo-random binary sequence, the pseudo-random binary sequence in particular being of maximum size.

A pseudo-random binary sequence (PRBS) is a data sequence composed of high values, namely of “1's”, and of low values, namely of “0's”. This type of sequence has particularly advantageous properties. Specifically, its autocorrelation function is maximum for a time shift of zero, i.e. when the sequence is compared with itself, and has a value substantially lower than this maximum for any other time shift, i.e. when the sequence is compared with time-shifted versions of itself. Moreover, the cross correlation function between two pseudo-random binary sequences is substantially less than the maximum of the autocorrelation functions of these sequences. Lastly, this type of sequence is generally generated by means of a linear feedback shift register (LFSR), which produces a periodic recursive sequence the pattern of which forms a pseudo-random binary sequence.

Given the autocorrelation properties of pseudo-random binary sequences, the computation unit may estimate values of a correlation function between a modulating sequence and a demodulated sequence extracted from a light beam received by the reception module. The correlation function will be maximum for the time shift corresponding to the time of flight of the emitted, reflected and then received modulated light beam, even when noise is high. Consequently, the computing unit may identify this time shift associated with the maximum value of the correlation function with high precision and deduce therefrom the distance separating the object from which the beam was reflected and the automotive vehicle. Furthermore, given the properties of the cross correlation, it is unlikely for reception of a modulated light beam emitted by an equivalent system of another automotive vehicle to lead to detection of a false positive. Lastly, it will be understood that the detection is based not on a single pulse but on a complete data sequence, and hence the signal-to-noise ratio of the system is improved.

Advantageously, the modulation unit is arranged to control the luminous module so that the first and second light beams have the same peak luminous power and the computation unit is arranged so that the first and second modulating data sequences are binary sequences and so that the first modulating data sequence contains a number of bits of value “0” different from the number of bits of value “0” of the second modulating data sequence. According to this feature, increasing the number of bits of value “0” in one of the modulating data sequences, so as to decrease its duty cycle, therefore allows the number or duration of the intervals separating consecutive pulses of the corresponding modulated light beam to be increased. The average luminous power of this beam is thus reduced. Conversely, decreasing the number of bits of value “0”, so as to increase the duty cycle, allows the number or duration of the pulses of the modulated light beam to be increased and therefore its average luminous power to be increased.

Advantageously, the modulation unit is arranged to generate a PWM control signal, with a view to modulation of said control signal using the modulating data sequence that it receives, and to control the emission of said light beam by the luminous module using the modulated control signal. For example, the modulation unit may be arranged to convert the modulating data sequence that it receives into a modulating signal and to modulate (for example amplitude modulate, frequency modulate or phase modulate) the control signal with this modulating signal. In particular, the modulation unit may control the luminous module so that said modulated light beam is emitted only for high values of said modulating data sequence received from the computation unit and so that the modulated light beam is emitted depending on said peak luminous power. It will thus be understood that each pulse of the modulated light beam is emitted with said peak luminous power and that the average luminous power of the emitted first or second modulated light beam, required to perform the first or second photometric function, is thus defined by the peak luminous power, the duty cycle of the first or second modulating data sequence and by the control signal.

In one embodiment of the invention, the computation unit is arranged so that the number of bits of the first modulating data sequence is identical to the number of bits of the second modulating data sequence. Therefore, the acquisition time of a data sequence demodulated by the reception module, so that the computation unit may detect the presence of a modulating sequence in a beam received by the reception module, remains constant whatever the photometric function performed. This feature thus allows the design of the computation unit to be simplified.

In one embodiment of the invention, the computation unit is arranged to generate a first initial pseudo-random binary sequence and a second initial sequence by cyclic sampling of the first initial sequence. Where appropriate, the computation unit is arranged to generate the first modulating data sequence by combining, using an “exclusive-or” function, the first initial sequence and the second initial sequence after it has been subjected to a circular shift by a first shift, and to generate the second modulating data sequence by combining, using an “exclusive-or” function, the first initial sequence and the second initial sequence after it has been subjected to a circular shift by a second shift different from the first shift. The first and second modulating sequences thus generated are so-called “Kasami” sequences belonging to the same set of Kasami sequences, containing a high number of sequences the cross-correlations of which are minimums and the number of “0's” of which varies from one sequence to another. Selecting which shift is applied to the second initial sequence thus makes it possible to control the number of “0's” of the modulating sequence, it being understood that the larger the shift gets, the more the number of “0's” decreases.

Advantageously, the computation unit is arranged so that the first modulating data sequence has a first duty cycle greater than the duty cycle of the second modulating data sequence. Provision may in particular be made for the duty cycle of the second modulating data sequence to be reduced by a factor of ten with respect to the first duty cycle. The first modulated light beam may thus perform a photometric function the luminous intensity of which is substantially greater than that of the photometric function performed by the second modulated light beam.

In one embodiment of the invention, the luminous module comprises a light source, the modulation unit being arranged to, on reception of the first modulating data sequence, control said light source with a view to emission of the first modulated light beam by the luminous module, and to, on reception of the second modulating data sequence, control said light source with a view to emission of the second modulated light beam by the luminous module. In other words, the same light source, and possibly the same optical unit, is used to selectively emit the first and second modulated light beams.

In one embodiment of the invention, the luminous module is capable of emitting a first light beam the spectrum of which has a wavelength in the visible domain, and in particular between 400 nm and 500 nm. Advantageously, the light source comprises a semiconductor generator capable of emitting an elementary light beam the spectrum of which in particular has a wavelength in the visible, and a photoluminescent element capable of converting said elementary light beam so as to obtain said light beam. Where appropriate, the modulation unit may be arranged to control the light source of the luminous module, and in particular an electrical power supply delivered to this light source, so as to modulate the light beam.

The semiconductor may for example be a gallium nitride (GaN) capable of emitting, by electroluminescence and in response to an electric current passing through it, blue light rays. The photoluminescent element may for example take the form of a resin comprising cerium-doped yttrium aluminum garnet (CE:YAG), capable of absorbing blue light and, by photoluminescence and in response to excitation by this light, of emitting yellow light rays. The photoluminescent element is placed on the generator so that some of the blue light rays excites this element such that it emits, by photoluminescence, orange light rays. The rest of the blue light rays passes through this element. Thus, the light source simultaneously emits, when it is supplied with electrical power, blue and yellow light rays, in proportions such that the light thus formed appears white to the human eye.

The light source may thus be a laser source, a light-emitting diode, a vertical-cavity surface-emitting laser (VCSEL) or even a superluminescent diode (SLD).

Advantageously, the luminous module may comprise an optical unit arranged to project the light rays emitted by the light source in order to form said light beam.

In one embodiment of the invention, the reception module comprises a plurality of elementary acquisition modules, each comprising at least one photodetector capable of converting a light signal that it receives into an electrical signal. Advantageously, the plurality of elementary acquisition modules is arranged in a matrix array. For example, the photodetectors of a given elementary acquisition module may together form a sensor, for example a single electronic component. Again for example, each photodetector, or each plurality of photodetectors, may have a width and/or length of less than about ten microns, this making it possible to obtain an elementary acquisition module with a reception field of at most 0.1° and therefore to increase the spatial resolution of the reception module.

Advantageously, the photodetector of the or each elementary acquisition module is a single-photon avalanche diode (SPAD). Thus, the SPADs may together form a silicon photomultiplier (SiPM). This type of photodetector is able to detect the incidence of a single photon with a high gain, for example of the order of 106, and therefore to compensate for the decrease in the signal-to-noise ratio due to external conditions.

According to one example of embodiment of the invention, the reception module may comprise an optical unit arranged in front of the elementary acquisition modules.

In one embodiment of the invention, the computation unit is arranged to determine a time of flight separating the emission of the emitted first or second modulated light beam, from the reception of a light beam received by the reception module, based on an electrical signal converted by the photodetector from said received light beam.

Advantageously, the luminous system comprises a demodulation unit connected to the photodetector and arranged to extract a data sequence, called the demodulated data sequence, from an electrical signal converted by this photodetector. Where appropriate, the computation unit is capable of receiving a data sequence demodulated by the demodulation unit from an electrical signal converted by the photodetector from a light beam received by the reception module and the computation unit is arranged to estimate values of a correlation function between said demodulated data sequence and said first or second modulating data sequence and to determine a time of flight separating the emission of said first or said second emitted modulated light beam, from the reception of said received light beam, based on values of the correlation function.

Each value of the correlation function estimated by the computation unit is associated with a value of one time shift of the modulating data sequence, or of the demodulated data sequence, employed to estimate this value of the correlation function. The correlation function between this demodulated data sequence and the modulating data sequence is therefore dependent on the autocorrelation of this modulating data sequence.

It is thus possible to detect the presence of this modulating data sequence in the received light beam, after reflection from an object in the environment of the vehicle and thus to detect the presence of this object and estimate its distance from the vehicle.

Preferably, the computation unit is arranged to determine a peak value of said correlation function, to compare said peak value to a predetermined threshold value and to detect the presence of said modulating data sequence in the demodulated data sequence based on said comparison. The computation unit may, for example, conclude that said modulating data sequence is present in said demodulated data sequence only if said peak value is greater than the predetermined threshold value.

For example, the or each elementary acquisition module is capable of generating an elementary detection signal depending on the one or more electrical signals converted by the one or more photodetectors of the elementary acquisition module, and each elementary acquisition module is arranged to compare said elementary detection signal with a threshold value associated with said elementary acquisition module and to generate a data sequence, called the demodulated data sequence, based on said comparison.

It is in particular conceivable for each elementary acquisition module to comprise a comparator arranged to compare said elementary detection signal with said threshold value associated with this elementary acquisition module and to generate said demodulated data sequence based on said comparison. The comparator thus forms a unit for demodulation of the light beam received by the reception module, capable of extracting a data sequence, called the demodulated data sequence, from the electrical signals converted by the photodetectors. As a variant, provision could be made to replace the comparator with active circuits.

In one embodiment of the invention, each elementary acquisition module comprises a plurality of photodetectors and at least one electronic component arranged to generate said elementary detection signal in light of the sum of the electrical signals converted by said photodetectors.

In one example of embodiment of the invention, the emission module is arranged in a front headlamp of the automotive vehicle. Preferably, the reception module and the emission module are arranged in the same front headlamp of the vehicle.

Advantageously, the luminous module is arranged so that the first modulated light beam contributes, wholly or partially, to performance of a first regulatory photometric function corresponding to the first instruction and so that the second modulated light beam contributes, wholly or partially, to performance of a second regulatory photometric function corresponding to the second instruction. Preferably, the luminous intensity of the second regulatory photometric function may be substantially lower than that of the first regulatory photometric function.

Again advantageously, the luminous module is arranged so that the first modulated light beam contributes, wholly or partially, to performance of a “daytime running light” first signaling function and so that the second modulated light beam contributes, wholly or partially, to performance of a “position light” second signaling function.

Another subject of the invention is a method for detecting an obstacle located in the environment of an automotive vehicle and for estimating the distance separating this object from the vehicle, the method being implemented by a luminous system according to the invention.

### BRIEF DESCRIPTION OF DRAWINGS

The present invention will now be described using examples that are merely illustrative and by no means limit the scope of the invention, and with reference to the appended drawings, in which the various figures show:

FIG. 1 schematically and partially shows a view of a range-finding system of an automotive vehicle according to one example of embodiment of the invention;

FIG. 2 schematically and partially shows one example of operation of the system of FIG. 1 during implementation of a range-finding method; and

FIG. 3 schematically and partially shows various data sequences generated by the computation unit of the range-finding system of FIG. 1 during its operation.

### DETAILED DESCRIPTION OF THE INVENTION

In the following description, elements that are identical in terms of structure or function and that appear in various figures have been designated by the same references, unless otherwise specified. Of course, various other modifications may be made to the invention within the scope of the appended claims.

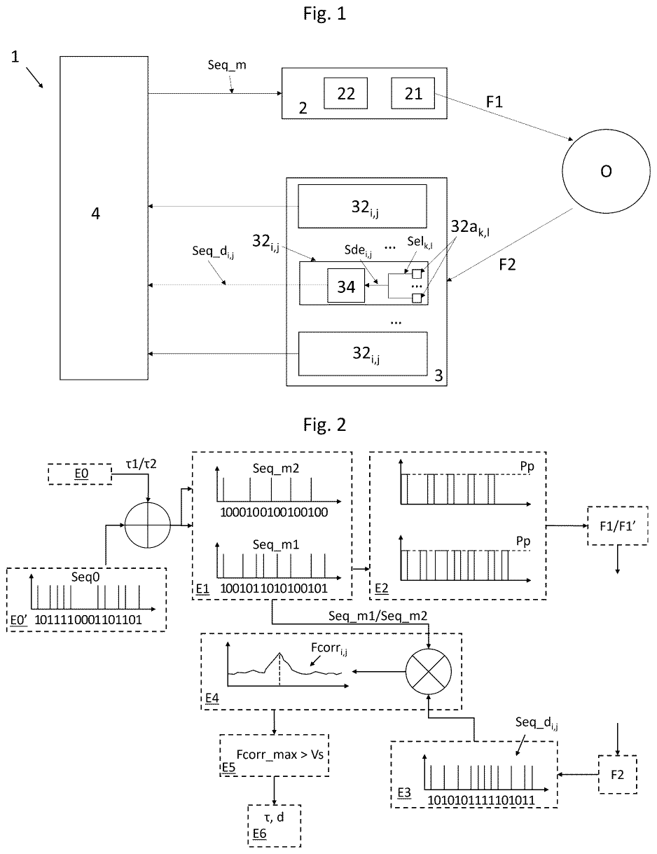

FIG. 1 shows a system 1 of an automotive vehicle according to one example of embodiment of the invention. The range-finding system 1 of a vehicle comprises an emission module 2 capable of emitting a light beam F1, a reception module 3 intended to receive a light beam F2, and a computation unit 4.

In the example described, the emission module 2 and the reception module 3 are arranged in the same front headlamp of the automotive vehicle. Provision could be made for the modules 2 and 3 to be arranged in different locations in the automotive vehicle, without departing from the scope of the present invention.

The emission module 2 comprises a luminous module 21 capable of emitting a light beam F1, and a modulation unit 22 that is capable of receiving a modulating data sequence Seq_m and that is arranged to modulate the emitted light beam F1 using said modulating sequence Seq_m.

The luminous module 21 is arranged so that the light beam F1 that it emits has an electromagnetic spectrum at least one portion of which is located in the visible spectrum. Preferably, the spectrum of this light beam F1 has an intensity peak, or line, in the blue at 450 nm. It will be noted that the spectrum has other intensity peaks, in the visible and/or in the infrared.

Insofar as the light beam F1 is partially or wholly composed of white light, it is possible to employ this light beam to partially or wholly participate in the performance of a plurality of predetermined, in particularly regulatory, photometric functions, as will be described below. In this case, the luminous module 21 may comprise an optical unit arranged to shape this light beam F1 so that its photometric distribution meets the requirements of any one of these functions.

In addition to this photometric function, the light beam F1 allows the system 1 to perform functions of detection and evaluation of the position of an obstacle on the road and/or of communication with another vehicle or with a piece of road infrastructure.

To these ends, the modulation unit 22 is arranged to modulate the light beam F1 emitted by the luminous module 21, using the modulating data sequence Seq_m that it receives, for example by controlling the electrical power supplied to the light source of the luminous module.

Provision may thus be made for the modulation unit 22 to comprise a generator of a PWM control signal (PWM standing for Pulse Width Modulation). This control signal makes it possible to control a switched-mode power supply (not shown) of the light source of the luminous module 21. Conventionally, the duty cycle of this control signal, which is set by the modulation unit 22, thus allows the average electrical power supplied to the light source to be controlled, and therefore the luminous intensity of the light beam F1 to be controlled, so as to meet the requirements of the photometric function that it performs.

In the example described, the modulation unit 22 is arranged to convert the data sequence Seq_m into a modulating signal and to modulate the initial control signal using this modulating signal. It will be noted that any of a number of different types of modulation may be employed within the scope of the present invention, and in particular on-off-keying (OOK), pulse-code modulation (PCM), pulse-amplitude modulation (PAM), pulse-width modulation (PWM), or even pulse-position modulation (PPM).

The light beam F1 thus emitted is composed of a train of successive light pulses that follow one after another at a rate that is sufficiently high, for example higher than 30 MHz, and in particular between 50 MHz and 100 MHz, for the human eye to no longer be able to distinguish between them. Moreover, the amplitude, width and/or position of each pulse with respect to the period allows the light beam F1 to transport the data sequence Seq_m.

If an object is present in the environment of the automotive vehicle, it may reflect this light beam F1 toward the reception module 3, which thus receives a light beam F2.

This reception module 3 comprises a plurality of elementary acquisition modules 32i,j. Each elementary acquisition module 32i,j comprises a plurality of photodetectors 32ak,l each capable of converting a light signal that it receives into an electrical signal Selk,l. Each elementary acquisition module 32i,j moreover comprises a demodulation unit 34, comprising a comparator, to the input of which all the outputs of the photodetectors 32ak,l are connected in parallel. The comparator thus receives an elementary detection signal Sdei,j formed by the sum of the electrical signals Selk,l delivered by these photodetectors 32ak,l. The comparator is arranged to compare this elementary detection signal Sdei, j with a given threshold value, the comparison giving a high value, or a “1”, when the elementary detection signal is greater than the threshold value, and a low value, or a “0”, when the elementary detection signal is less than the threshold value. The demodulation unit 34 is thus arranged to generate a demodulated binary sequence Seq_di,j, which it transmits to the computation unit 4. Provision could be made, as a variant, to replace the comparator of the demodulation unit 34 with active circuits, the demodulated data sequence in this case being a digital sequence formed by “1's” and “0's” directly.

In the example described, the photodetectors 32ak,l are identical and are each formed by a single-photon avalanche photodiode, or SPAD, these photodiodes and the demodulation unit 34 being integrated into a silicon photomultiplier, or SiPM. It will be noted that the dimensions of the photodetectors are of the order of one micron. The assembly thus forms a sensor the reception spatial resolution of which is of the order of 1°, or even 0.1°, and the detection capabilities of which are particularly high, even in the event of degraded acquisition conditions, due to the use of avalanche photodiodes.

The computation unit 4 is capable of receiving the demodulated binary sequences Seq_di,j generated by the elementary acquisition modules 32i,j and of detecting in each demodulated binary sequence Seq_di,j the presence of the modulating data sequence Seq_m. The demodulation units 34 thus make it possible to decrease the amount of data that has to be manipulated by the computation unit, and therefore a compression of the elementary detection signals Sdei,j is achieved.

To these ends, the computation unit 4 is thus arranged to estimate values of a correlation function Fcorri,j between each demodulated binary sequence Seq_di,j and said modulating data sequence Seq_m, and to detect in this demodulated binary sequence Seq_di,j, the presence of the modulating data sequence Seq_m based on these values of the correlation function Fcorri,j. In the event of detection, it may then determine a time of flight t separating the emission of said emitted modulated light beam F1 from the reception of said received light beam F2.

The computation unit 4 is thus able to perform functions of detection and evaluation of the position of an object on the road, as will be described with reference to FIG. 2 which shows a range-finding method implemented by the luminous system 1.

As indicated above, the luminous module 21 is capable of selectively performing various functions through the same exit surface, such as a DRL first function (DRL standing for Daytime Running Light) and a “position light” second function.

In order to be able to activate one or other of these functions, the computation unit 4 receives, in a step E0, an instruction to emit one or other of these first and second photometric functions.

This instruction will for example originate from a central computer (not shown) of the automotive vehicle, and be determined by the central computer, for example depending on traffic parameters of the automotive vehicle, on information from various sensors such as a camera filming the road, a steering-wheel angle sensor, or a navigation system.

Depending on the instruction received, the computation unit determines a duty cycle τ1 or τ2 according to the photometric function indicated by this instruction, and generates either a first modulating data sequence Seq_m1 or a second modulating data sequence Seq_m2.

To these ends, the computation unit generates, in a step E0′, an initial pseudo-random binary sequence Seq0 of maximum size.

Next, in a step E1, the computation unit periodically generates:
a. either said first modulating data sequence Seq_m1 from the initial sequence Seq0, the first modulating data sequence having the first duty cycle τ1;
b. or said second modulating data sequence Seq_m2 from the initial sequence Seq0, the second modulating data sequence having the second duty cycle τ2.

It will be noted that, whatever the duty cycle τ1 or τ2, the number of bits of the first modulating data sequence Seq_m1 is identical to the number of bits of the second modulating data sequence Seq_m2. Moreover, taking into account the photometric functions that the luminous module 21 must perform, the value of the first duty cycle τ1 is greater than the value of the second duty cycle τ2, in particular by a factor of 10. In other words, the number of bits of value “0” of the first sequence Seq_m1 is greater than the number of bits of value “0” of the second sequence Seq_m2.

The computation unit 4 transmits the modulating data sequence Seq_m1 or Seq_m2 thus generated to the modulation unit 22 of the emission module 2 with a view to emission of a light beam F1 or F1′ by the emission module 2.

In a second step E2, the modulation unit 22 modulates the light beam emitted by the luminous module 21 based on this data sequence Seq_m1 or Seq_m2 to obtain a modulated light beam F1 or F1′.

It will be noted that, in the example described, each light pulse of the light beam F1 or F1′ emitted by the luminous module 21 corresponds to a bit of value “1” of the modulating sequence Seq_m1 or Seq_m2. The average power of a portion of the light beam F1/F1′ containing the sequence Seq_m1 or Seq_m2 is thus defined by the number of bits of value “1” of this sequence Seq_m1 or Seq_m2 in relation to the total number of bits of this sequence, by the duration of the pulses and by the peak power Pp of these pulses.

Insofar as the peak luminous power Pp is the same for each of the data sequences Seq_m1 or Seq_m2, the average power of the light beam F1 modulated by the first sequence Seq_m1 is therefore substantially greater than that of the light beam F1′ modulated by the second sequence Seq_m2. Specifically, this first beam F1 contains more light pulses and/or longer light pulses than the second beam F1′, on account of the relative value of the duty cycles τ1 and τ2. The light beam F1 may thus perform a photometric function of substantial intensity, such as a daytime running light, while the light beam F1′ may perform a weaker photometric function, such as a position light, without the peak luminous power Pp of the pulses being impacted.

The light beam F1/F1′ is thus emitted and then reaches an object O located in the environment of the vehicle, which reflects it in the direction of the reception module 3.

Depending on the angular position of the object O, the light beam F2 received by the reception module 3 is thus concentrated on one of the elementary acquisition modules 32i,j.

When the sunshine conditions in the vicinity of the vehicle are particularly bright, the sunlight is thus added to the light beam F2 received by the reception module 3. The light beam F2 received by the reception module 3 is thus composed of part of the light beam F1/F1′ reflected by the object O and of noise, for example noise generated by parasitic light sources such as urban lighting, automobile lighting, or even the sun.

In a third step E3, each of the elementary acquisition modules 32i,jthus extracts, by means of its demodulation unit 34, a demodulated binary sequence Seq_di,j which it transmits to the computation unit 4.

For each demodulated binary sequence Seq_di,j that it receives, the computation unit 4 estimates, in a fourth step E4, values of a correlation function Fcorri,j between the modulating sequence Seq_m1 or Seq_m2 that was employed to modulate the emitted light beam F1/F1′ and this demodulated binary sequence Seq_di,j.

It will be noted that, insofar as these modulating sequences Seq_m1 or Seq_m2 contain an identical number of bits, the acquisition time of a demodulated data sequence remains constant whatever the photometric function performed by the emitted light beam F1/F1′.

The computation unit 4 thus evaluates the cross-correlation for a plurality of time shifts, by means of a cyclic convolution product between each demodulated binary sequence Seq_di,j and the modulating sequence Seq_m1 or Seq_m2 delayed by each of the time shifts.

Given the autocorrelation and cross-correlation properties of the modulating sequence, the correlation function Fcorri,j will thus be maximum for a time shift corresponding to the time of flight of the light beam F1, i.e. to the length of time separating the time at which the light beam was emitted by the emission module 2 and the time at which it was received by the elementary acquisition module 32i,j of the reception module 3, the modulating sequence Seq_m1 or Seq_m2 delayed by this shift thus corresponding substantially to the demodulated binary sequence Seq_di,j, neglecting any noise.

In a fifth step E5, the computation unit 4 identifies the maximum value Fcorr_max of each correlation function Fcorri,j associated with each elementary acquisition module 32i,j and compares it with a threshold value Vs.

In the case where this maximum value Fcorr_max is greater than the threshold value Vs, the modulating sequence Seq_m1 or Seq_m2 is considered to be detected by the computation unit 4 in the demodulated binary sequence Seq_di,j delivered by the elementary acquisition module 32i,j associated with this correlation function Fcorri,j. An object O is therefore detected in the angular range, or pixel, monitored by this elementary acquisition module 32i,j and the computation unit 4 may then estimate, in a sixth step E6, the value τ of the time of flight, of the emitted light beam F1/F1′ between the object O and the vehicle, associated with this maximum value, and also the distance d separating the object O from the vehicle.

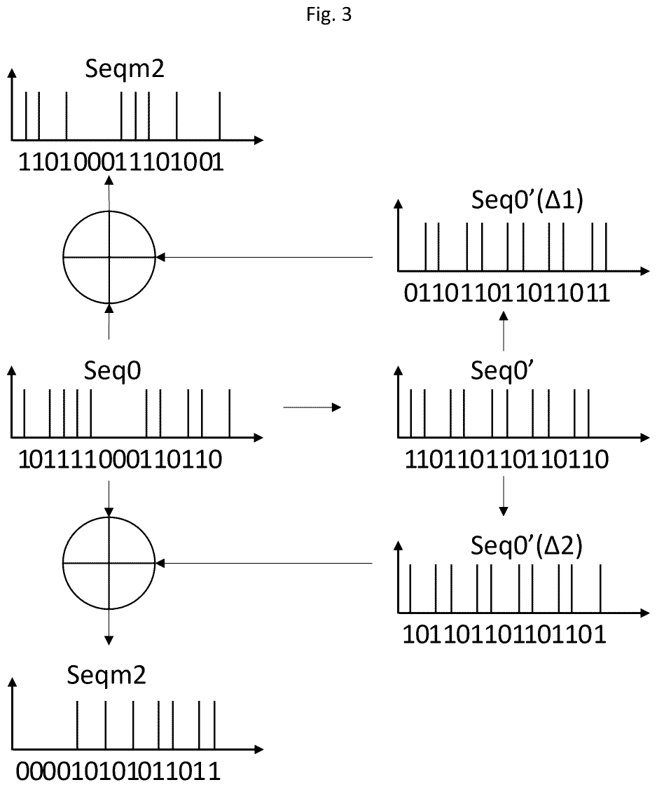

With reference to FIG. 3, one example of embodiment of a computation unit allowing generation of modulating sequences Seq_m1 and Seq_m2 having autocorrelation and intercorrelation properties that meet the needs of the invention and the duty cycle of which may be controlled, will now be described.

The computation unit 4 generates beforehand a first initial pseudo-random binary sequence of maximum size Seq0, for example by means of a linear feedback shift register.

The computation unit 4 then generates a second initial sequence Seq0′ by cyclic sampling of the first initial sequence. Each bit of the second initial sequence Seq0′ thus has the value of one bit of the first initial sequence Seq0 the rank of which corresponds to the rank of the bit of the second initial sequence that it is sought to compute, multiplied by a coefficient computed depending on the length of the first initial sequence Seq0, modulo this length of the first initial sequence Seq0.

This second initial sequence Seq0′ thus undergoes a circular shift by a value Δ1 for the computation of the first modulating sequence Seq_m1 and by a value Δ2 for the computation of the second modulating sequence Seq_m2. The value Δ2 will be greater than the value Δ1 so as to ensure that the number of “0's” of the second modulating sequence Seq_m2 is greater than the number of “0's” of the first modulating sequence Seq_m1.

Lastly, the computation unit combines, using an “exclusive-or” function, the first initial sequence Seq0 and the circular shift of the second initial sequence Seq0′(Δ1) to generate the first modulating data sequence Seq_m1, and the first initial sequence Seq0 and the circular shift of the second initial sequence Seq0′(Δ2) to generate the second modulating data sequence Seq_m2.

These first and second modulating sequences Seq_m1 and Seq_m2 are thus so-called “Kasami” sequences belonging to the same set of Kasami sequences.

The foregoing description clearly explains how the invention achieves the objectives that were set, namely to provide a luminous system comprising a luminous module capable of performing, at the same time, two different photometric functions and a range-finding function, the performance of the range-finding function remaining substantially constant whatever the photometric function performed. These objectives are in particular achieved by configuring the value of the duty cycle of the data sequence modulating the light beam emitted by the luminous module depending on the photometric function that the luminous module must perform.

In any event, the invention is not limited to the embodiments specifically described in this document and particularly extends to all equivalent means and to any technically operative combination of these means. In particular, provision could be made for the emission module to have other configurations, and in particular for the emission module to employ types of light source other than those described, such as a laser diode, a VCSEL or a SLED or an RGB diode. Provision could also be made for photometric functions other than those described, and in particular low-beam lighting functions or stop-light or tail-light signaling functions, to be performed. Provision could even be made to use methods for generating a modulating sequence other than those described.

What is claimed is:

1. A luminous system for an automotive vehicle, comprising:
a. an emission module including a luminous module capable of emitting a light beam, the spectrum of which has at least one portion in the visible spectrum, and a modulation unit that is capable of receiving a data sequence, and that is arranged to modulate the emitted light beam using the received data sequence;
b. a reception module capable of receiving a light beam, wherein the reception module includes an elementary acquisition module including a photodetector capable of converting a light signal it receives into an electrical signal;
a computation unit capable of receiving a first instruction to emit a given first photometric function and arranged to, on reception of the first instruction, generate a first modulating data sequence having a first duty cycle and to transmit the first modulating data sequence to the modulating unit with a view to emission of a first modulated light beam by the luminous module, in that the computation unit is capable of receiving a second instruction to emit a given second photometric function and in that the computation unit is arranged to, on reception of the second instruction, generate a second modulating data sequence having a second duty cycle different from the first duty cycle and to transmit the second modulating data sequence to the modulating unit with a view to emission of a second modulated light beam by the luminous module.

2. The luminous system as claimed in claim 1, wherein the modulation unit is arranged to control the luminous module so that the first and second light beams have the same peak luminous power and in that the computation unit is arranged so that the first and second modulating data sequences are binary sequences and so that the first modulating data sequence contains a number of bits of value “0” different from the number of bits of value “0” of the second modulating data sequence.

3. The luminous system as claimed in claim 2, wherein the computation unit is arranged so that the number of bits of the first modulating data sequence is identical to the number of bits of the second modulating data sequence.

4. The range-finding system as claimed in claim 1, wherein the computation unit is arranged to generate a first initial pseudo-random binary sequence and a second initial pseudo-random binary sequence by cyclic sampling of the first initial pseudo-random binary sequence, and to generate the first modulating data sequence by combining, using an “exclusive-or” function, the first initial pseudo-random binary sequence and the second initial pseudo-random binary sequence after it the second pseudo-random binary sequence has been subjected to a circular shift by a first shift, and to generate the second modulating data sequence by combining, using an “exclusive-or” function, the first initial pseudo-random binary sequence and the second initial pseudo-random binary sequence after the second initial pseudo-random binary sequence has been subjected to a circular shift by a second shift different from the first shift.

5. The luminous system as claimed in claim 1, wherein characterized computation unit is arranged so that the first modulating data sequence has a first duty cycle greater than the duty cycle of the second modulating data sequence.

6. The luminous system as claimed in claim 1, wherein the luminous module comprises includes a light source, the modulation unit being arranged to, on reception of the first modulating data sequence, control the light source with a view to emission of the first modulated light beam by the luminous module, and to, on reception of the second modulating data sequence, control the light source with a view to emission of the second modulated light beam by the luminous module.

7. The luminous system as claimed in claim 1, wherein the computation unit is arranged to determine a time of flight separating the emission of the emitted first or second modulated light beam, from the reception of a light beam received by the reception module, based on an electrical signal converted by the photodetector from the received light beam.

8. The luminous system as claimed in claim 7, further comprising a demodulation unit connected to the photodetector and arranged to extract a data sequence, called the demodulated data sequence, from an electrical signal converted by the photodetector, and in that, the computation unit being capable of receiving a data sequence demodulated by the demodulation unit from an electrical signal converted by the photodetector from a light beam received by the reception module, the computation unit is arranged to estimate values of a correlation function between the demodulated data sequence and the first or second modulating data sequence and to determine a time of flight separating the emission of the first or the second emitted modulated light beam, from the reception of the received light beam, based on values of the correlation function.

9. The luminous system as claimed claim 1, wherein the emission module is arranged in a front headlamp of the automotive vehicle.

10. The luminous system as claimed in claim 9, wherein the luminous module is arranged so that the first modulated light beam contributes, wholly or partially, to performance of a first regulatory photometric function corresponding to the first instruction and so that the second modulated light beam contributes, wholly or partially, to performance of a second regulatory photometric function corresponding to the second instruction.

11. The luminous system as claimed in claim 10, wherein the luminous module is arranged so that the first modulated light beam contributes, wholly or partially, to performance of a “daytime running light” first signaling function and so that the second modulated light beam contributes, wholly or partially, to performance of a “position light” second signaling function.
